(19) United States
(12) Patent Application Publication
(10) Pub. No.: US 2023/0117514 A1
(43) Pub. Date: Apr. 20, 2023

(54) Vehicle Locating Assembly

(71) Applicant: Andrew Smith, Mentone, AL (US)

(72) Inventor: Andrew Smith, Mentone, AL (US)

(21) Appl. No.: 17/501,612

(22) Filed: Oct. 14, 2021

(51) Int. Cl. G06K 7/10; H01Q 1/22; G06K 19/07

(52) U.S. Cl. CPC G06K 7/10475; H01Q 1/2208; G06K 19/0723; G06K 19/0709

(57) ABSTRACT

A vehicle locating assembly for locating a suspect licensed vehicle includes a computer, a plurality of RFID tags, and a plurality of interrogators. A database is positioned on the computer and comprises a list of licensed vehicles, each of which is assigned a unique identifier. Each RFID tag is engaged to a respective license plate of a plurality of license plates, with the respective license plate being affixed to an associated licensed vehicle. The unique identifier of the associated licensed vehicle is written on the RFID tag. The interrogators are communicatively engaged to the computer and are mounted to create an array across a network of roads. The interrogator selectively powers the RFID tags so that they transmit their respective unique identifiers. The interrogator receives the respective unique identifiers and communicates them to the computer. The computer the isolates a unique identifier of a suspect licensed vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to locating assemblies and more particularly pertains to a new locating assembly for locating a suspect licensed vehicle. The present invention discloses a locating assembly comprising a plurality of tags, each of which is embedded in a license plate of a respective vehicle, and a plurality of interrogators, which can read the tags to locate a suspect licensed vehicle.

### Description of Related Art Including Information Disclosed Under 37 CFR 1.97 and 1.98.

The prior art relates to locating assemblies. The prior art locating assemblies may comprise radio-frequency identification (RFID) chips, which are incorporated into license plates, and a reader to interrogate a respective RFID chip. What is lacking in the prior art is a locating assembly comprising a plurality of interrogators arrayed across a network of roads, such that a suspect licensed vehicle can be located.

### BRIEF SUMMARY OF THE INVENTION

An embodiment of the disclosure meets the needs presented above by generally comprising a computer, a plurality of tags, and a plurality of interrogators. A database is positioned on the computer and comprises a list of licensed vehicles, each of which is assigned a unique identifier. Each tag is engaged to a respective license plate of a plurality of license plates, with the respective license plate being affixed to an associated licensed vehicle. The tag comprises an antenna and a chip. The unique identifier of the associated licensed vehicle is written on the chip.

Each interrogator is communicatively engaged to the computer and is configured to be mounted to a substrate proximate to a respective road so that the plurality of interrogators is arrayed across a network of roads. The interrogator comprises a transmitter, which is configured to selectively emit electromagnetic radiation to antennae of tags proximate to the interrogator to power the tags so that the tags transmit their respective unique identifiers. The interrogator comprises a receiver, which is configured to receive the respective unique identifiers for communication by the interrogator to the computer. The computer is configured to isolate a unique identifier of a suspect licensed vehicle to locate the suspect licensed vehicle based on its proximity to a respective interrogator that communicates the unique identifier of the suspect licensed vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a vehicle locating assembly according to an embodiment of the disclosure.

FIG. 2 is an in-use view of an embodiment of the disclosure.

FIG. 3 is a back view of an embodiment of the disclosure.

FIG. 4 is a cross-sectional view of an embodiment of the disclosure.

FIG. 5 is an in-use view of an embodiment of the disclosure.

FIG. 6 is an in-use view of an embodiment of the disclosure.

FIG. 7 is an in-use view of an embodiment of the disclosure.

### DETAILED DESCRIPTION OF THE INVENTION

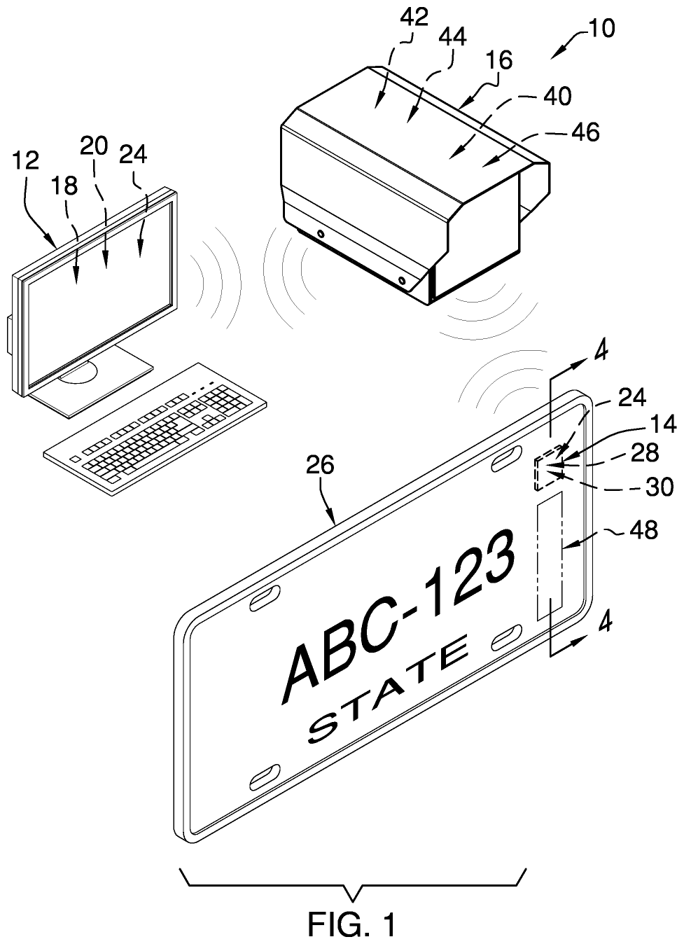

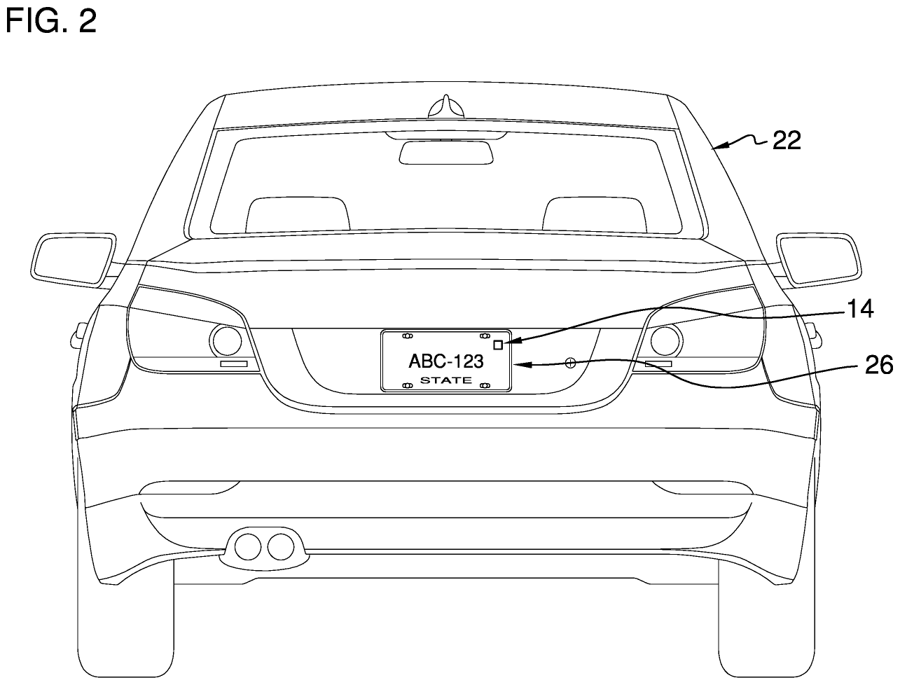

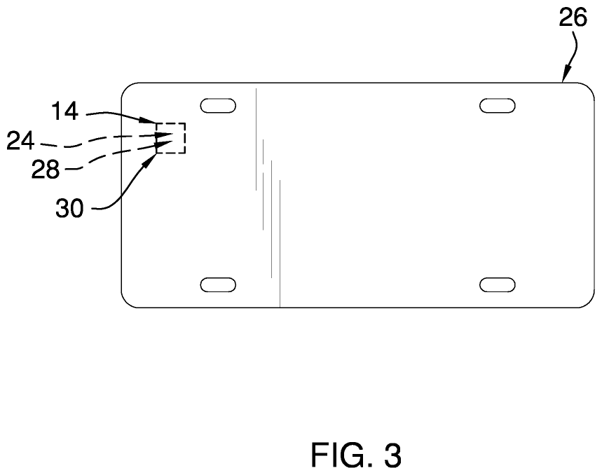

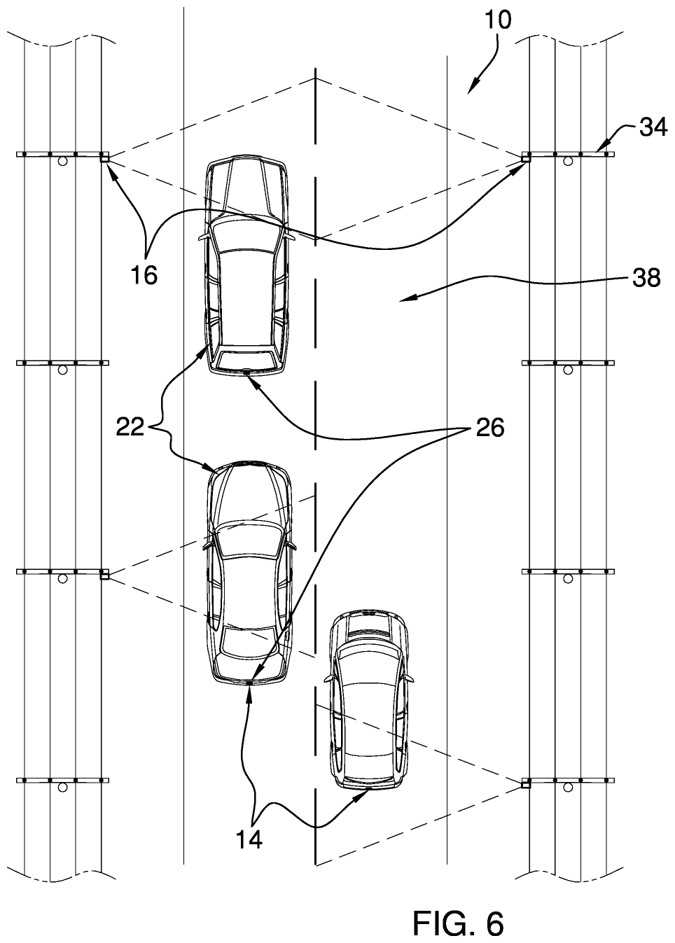

With reference now to the drawings, and in particular to FIGS. 1 through 7 thereof, a new locating assembly embodying the principles and concepts of an embodiment of the disclosure and generally designated by the reference numeral 10 will be described.

As best illustrated in FIGS. 1 through 7, the vehicle locating assembly 10 generally comprises a computer 12, a plurality of tags 14, and a plurality of interrogators 16. A database 18 is positioned on the computer 12 and comprises a list 20 of licensed vehicles 22, each of which is assigned a unique identifier 24.

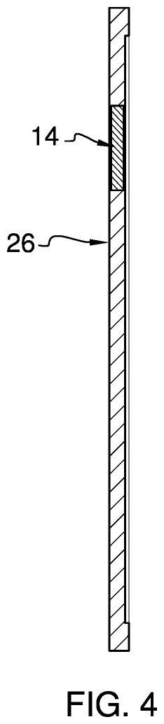

Each tag 14 is engaged to a respective license plate 26 of a plurality of license plates 26, with the respective license plate 26 being affixed to an associated licensed vehicle 22. The tag 14 comprises an antenna 28 and a chip 30. The unique identifier 24 of the associated licensed vehicle 22 is written on the chip 30. The tag 14 is read only. The tag 14 may be powered by electromagnetic radiation, such as, but not limited to, radio waves, although the present invention also anticipates the tag 14 being at least partially battery powered. The tag 14 may be embedded in the respective license plate 26, as shown in FIG. 4, although the present invention anticipates the tag 14 being affixed to the respective license plate 26 by other attachment means, such as, but not limited to, adhesives, tapes, and the like. Additionally, as shown in FIG. 1, the tag 14 may be configured as a strip 48, which is adhesively engageable to the respective license plate 26.

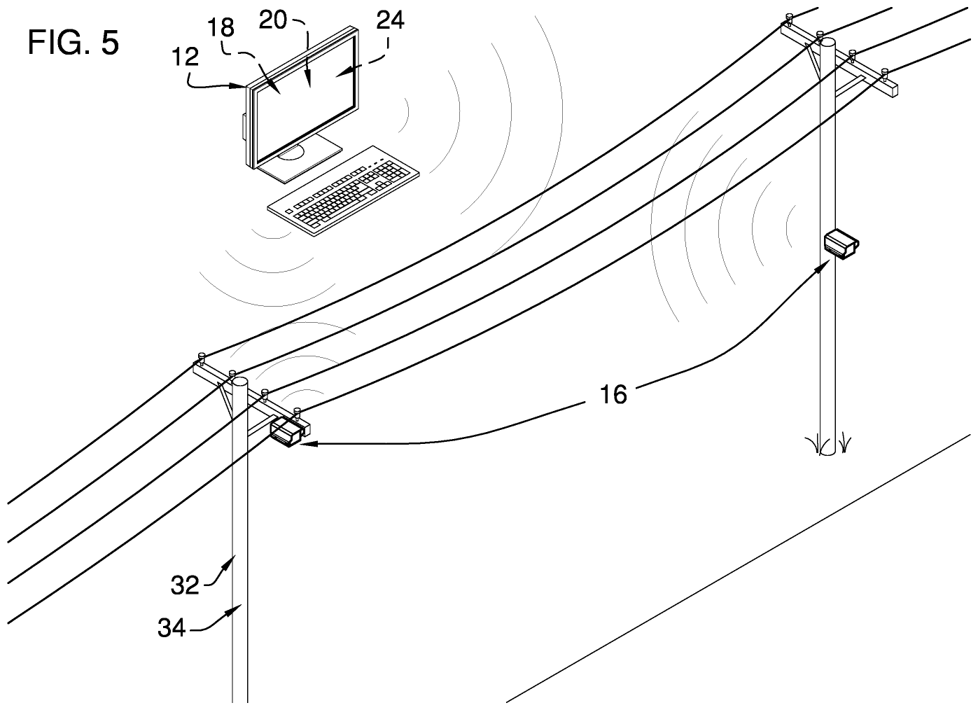

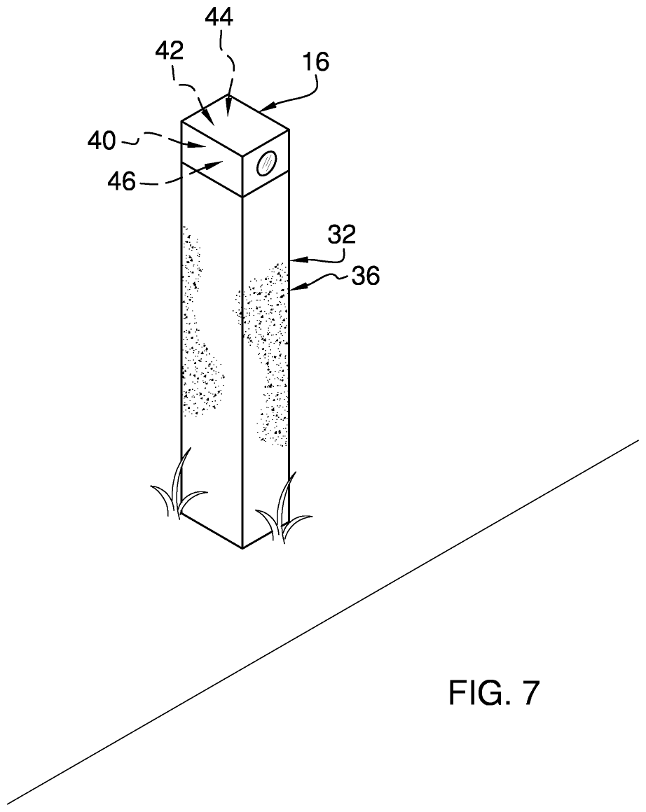

Each interrogator 16 is communicatively engaged to the computer 12 and is configured to be mounted to a substrate 32, such as a utility pole 34, as shown in FIG. 5, a pillar 36, as shown in FIG. 7, and the like. The substrate 32 is proximate to a respective road 38 so that the plurality of interrogators 16 is arrayed across a network of roads 38. The interrogator 16 comprises a transmitter 40, which is configured to selectively emit electromagnetic radiation to antennae 28 of tags 14 proximate to the interrogator 16 to power the tags 14 so that the tags 14 transmit their respective unique identifiers 24. The interrogator 16 also comprises a receiver 46, which is configured to receive the respective unique identifiers 24 for communication by the interrogator 16 to the computer 12.

The computer 12 is configured to isolate a unique identifier 24 of a suspect licensed vehicle 22 to locate the suspect licensed vehicle 22 based on its proximity to a respective interrogator 16 that communicates the unique identifier 24 of the suspect licensed vehicle 22.

The interrogator 16 may be programmed to selectively perform one of a slotted Aloha protocol 42 and an adaptive binary tree protocol 44 to facilitate isolation of the unique identifier 24 of the suspect licensed vehicle 22. Implementing the adaptive binary tree protocol 44 reduces privacy concerns as only the tag 14 corresponding to the suspect licensed vehicle 22 will be fully read and identified.

In use, the plurality of interrogators 16 is actuated by law enforcement in event of an AMBER alert or other emergency requiring rapid location of a suspect licensed vehicle 22. When the suspect licensed vehicle 22 is in proximity to a respective interrogator 16, radio waves emitted by the respective interrogator 16 power the tag 14 embedded in the license plate 26 of the suspect licensed vehicle 22 so that it transmits its unique identifier 24. The computer 12 receives the unique identifier 24 and correlates the location of the suspect licensed vehicle 22 with the respective interrogator 16, allowing law enforcement to intercede.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A vehicle locating assembly comprising:
a computer;
a database positioned on the computer and comprising a list of licensed vehicles, each licensed vehicle being assigned a unique identifier in the database;
a plurality of license plates, each license plate being affixed to a respective licensed vehicle;
a plurality of tags, each tag being engaged to a respective license plate, wherein each tag is embedded in the respective license plate, the tag comprising:
an antenna, and a chip, the unique identifier of an associated licensed vehicle being written on the chip;
a plurality of interrogators, each interrogator being communicatively engaged to the computer, the interrogator being configured for mounting to a substrate proximate to a respective road, such that the plurality of interrogators is arrayed across a network of roads, the interrogator comprising:
a transmitter configured for selectively emitting electromagnetic radiation to antennae of tags proximate to the interrogator for powering the tags, such that the tags transmit their respective unique identifiers, and
a receiver configured for receiving the respective unique identifiers for communication by the interrogator to the computer; and
wherein the computer is configured for isolating a unique identifier of a suspect licensed vehicle for locating the suspect licensed vehicle based on its proximity to a respective interrogator communicating the unique identifier of the suspect licensed vehicle.

2. The vehicle locating assembly of claim 1, wherein the interrogator is programmed to selectively perform one of a slotted Aloha protocol and an adaptive binary tree protocol, for facilitating isolation of the unique identifier of the suspect licensed vehicle.

3. The vehicle locating assembly of claim 1, wherein the interrogator is configured for selectively mounting to a utility pole and a pillar.

4. The vehicle locating assembly of claim 1, wherein the tag is powered by radio waves.

5. The vehicle locating assembly of claim 1, wherein the tag is read only.

6. (canceled)

7. A vehicle locating system comprising:
a plurality of licensed vehicles;
a plurality of license plates, each license plate being affixed to a respective licensed vehicle;
a computer;
a database positioned on the computer and comprising a list of the licensed vehicles, each licensed vehicle being assigned a unique identifier in the database;
a plurality of tags, each tag being engaged to a respective license plate, wherein each tag is embedded in the respective license plate, the tag comprising:
an antenna, and
a chip, the unique identifier of an associated licensed vehicle being written on the chip;
a plurality of interrogators, each interrogator being communicatively engaged to the computer, the interrogator being mounted to a substrate proximate to a respective road, such that the plurality of interrogators is arrayed across a network of roads, the interrogator comprising:
a transmitter configured for selectively emitting electromagnetic radiation to antennae of tags proximate to the interrogator for powering the tags, such that the tags transmit their respective unique identifiers, and
a receiver configured for receiving the respective unique identifiers for communication by the interrogator to the computer; and
wherein the computer is configured for isolating a unique identifier of a suspect licensed vehicle for locating the suspect licensed vehicle based on its proximity to a respective interrogator communicating the unique identifier of the suspect licensed vehicle.

8. The vehicle locating system of claim 7, wherein the interrogator is programmed to selectively perform one of a slotted Aloha protocol and an adaptive binary tree protocol, for facilitating isolation of the unique identifier of the suspect licensed vehicle.

9. The vehicle locating system of claim 7, wherein the interrogator is mounted to a utility pole or a pillar.

10. The vehicle locating system of claim 7, wherein the tag is powered by radio waves.

11. The vehicle locating system of claim 7, wherein the tag is read only.

12. (canceled)

11. The vehicle locating assembly comprising:
a computer;
a database positioned on the computer and comprising a list of licensed vehicles, each licensed vehicle being assigned a unique identifier in the database;
a plurality of license plates, each license plate being affixed to a respective licensed vehicle;
a plurality of tags, each tag being embedded in a respective license plate, the tag comprising:
an antenna, and
a chip, the unique identifier of an associated licensed vehicle being written on the chip, the tag being read only;
a plurality of interrogators, each interrogator being communicatively engaged to the computer, the interrogator being configured for selectively mounting to a utility pole and a pillar proximate to a respective road, such that the plurality of interrogators is arrayed across a network of roads, the interrogator comprising:
a transmitter configured for selectively emitting radio waves to antennae of tags proximate to the interrogator for powering the tags, such that the tags transmit their respective unique identifiers, and
a receiver configured for receiving the respective unique identifiers for communication by the interrogator to the computer; and
the interrogator being programmed to selectively perform one of a slotted Aloha protocol and an adaptive binary tree protocol, for facilitating isolation of the unique identifier of the suspect licensed vehicle, wherein the computer is configured for isolating a unique identifier of a suspect licensed vehicle for locating the suspect licensed vehicle based on its proximity to a respective interrogator communicating the unique identifier of the suspect licensed vehicle.
